(19) United States
(12) Patent Application Publication
(10) Pub. No.: US 2014/0121988 A1
(43) Pub. Date: May 1, 2014

(54) SYSTEM AND METHOD FOR ALIGNING GENOME SEQUENCE CONSIDERING REPEATS

(71) Applicant: SAMSUNG SDS CO., LTD., Seoul (KR)

(72) Inventor: Minseo PARK, Seoul (KR)

(73) Assignee: SAMSUNG SDS CO., LTD., Seoul (KR)

(21) Appl. No.: 13/974,357

(22) Filed: Aug. 23, 2013

(30) Foreign Application Priority Data
Oct. 29, 2012 (KR) 10-2012-0120635

(51) Int. Cl. G06F 19/22

(52) U.S. Cl. CPC G06F 19/22
USPC 702/19

(57) ABSTRACT

A system and a method for aligning a genome sequence considering repeats are provided. The system for aligning a genome sequence includes a fragment sequence production unit configured to produce a plurality of fragment sequences from a read, a fragment sequence length adjustment unit configured to select the fragment sequences whose mapping repeat numbers in a target sequence exceed a predetermined reference value from the plurality of produced fragment sequences and adjust lengths of the selected fragment sequences until the mapping repeat numbers of the selected fragment sequences reach a value equal to or less than the reference value, and an alignment unit configured to perform global alignment using the fragment sequences having the adjusted lengths.

### CROSS-REFERENCE TO RELATED APPLICATION

This application claims priority to and the benefit of Republic of Korea Patent Application No. 10-2012-0120635, filed on Oct. 29, 2012, the disclosure of which is incorporated herein by reference in its entirety.

### BACKGROUND

1. Field

The present disclosure relates to technology for analyzing a genome sequence.

2. Discussion of Related Art

A next-generation sequencing (NGS) method of producing a large amount of short sequences is rapidly replacing the conventional Sanger's sequencing method due to its inexpensive cost and rapid data generation. Also, various programs for aligning an NGS sequence have developed with a focus on accuracy. However, a cost required to construct a fragment sequence has been reduced to less than half the cost required in the past with current developments in next-generation sequencing technology. As a result, as a quantity of the data is increasingly used, technology for rapidly and accurately processing a large amount of short sequences is required.

The first operation of aligning a sequence is to map a read at an exact position of a reference sequence using an algorithm for aligning a genome sequence. In this case, it is problematic that there are differences in genomes sequence due to the presence of various genetic variations even among subjects of the same species. Also, differences in genome sequences may be caused due to errors in a sequencing process. Therefore, the algorithm for aligning a genome sequence has to effectively enhance mapping accuracy in consideration of the differences in genome sequences and the genetic variations.

In conclusion, as much data on the entire genomic information as possible is required so as to analyze the genomic information. For this purpose, development of an algorithm for aligning a genome sequence, which has excellent accuracy and high throughput, should also be achieved in advance. However, the conventional methods have limits in satisfying these requirements.

### SUMMARY

The present disclosure is directed to a means for aligning a genome sequence capable of ensuring mapping accuracy and simultaneously improving complexity upon mapping to increase a processing rate.

According to an aspect of the present disclosure, there is provided a system for aligning a genome sequence, which includes a fragment sequence production unit configured to produce a plurality of fragment sequences from a read, a fragment sequence length adjustment unit configured to select the fragment sequences whose mapping repeat numbers in a target sequence exceed a predetermined reference value from the plurality of produced fragment sequences and adjust lengths of the selected fragment sequences until the mapping repeat numbers of the selected fragment sequences reach a value equal to or less than the reference value, and an alignment unit configured to perform global alignment using the fragment sequences.

According to another aspect of the present disclosure, there is provided a system for aligning a genome sequence, which includes a fragment sequence production unit configured to produce a plurality of fragment sequences from a read, a filtering unit configured to discard the fragment sequences whose mapping repeat numbers in a target sequence exceed a predetermined upper limit from the plurality of produced fragment sequences, and an alignment unit configured to perform global alignment on the remaining fragment sequences.

According to still another aspect of the present disclosure, there is provided a method of aligning a genome sequence, which includes producing a plurality of fragment sequences from a read at a fragment sequence production unit, selecting the fragment sequences whose mapping repeat numbers in a target sequence exceed a predetermined reference value from the plurality of produced fragment sequences and adjusting lengths of the selected fragment sequences until the mapping repeat numbers of the selected fragment sequences reach a value equal to or less than the reference value at a fragment sequence length adjustment unit, and performing global alignment using the fragment sequences at an alignment unit.

According to yet another aspect of the present disclosure, there is provided a method of aligning a genome sequence, which includes producing a plurality of fragment sequences from a read at a fragment sequence production unit, discarding the fragment sequences whose mapping repeat numbers in a target sequence exceed a predetermined upper limit from the plurality of produced fragment sequences at a filtering unit, and performing global alignment on the remaining fragment sequences.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram explaining a method of aligning a genome sequence according to one exemplary embodiment of the present disclosure;

FIG. 2 is a diagram exemplifying a process of calculating an error margin e in the method of aligning a genome sequence according to one exemplary embodiment of the present disclosure;

FIG. 3 is a diagram showing one example of a process of extracting a fragment sequence in the method of aligning a genome sequence according to one exemplary embodiment of the present disclosure;

FIG. 4 is a block diagram showing a system 400 for aligning a genome sequence according to one exemplary embodiment of the present disclosure; and

FIG. 5 is a block diagram showing a system 500 for aligning a genome sequence according to another exemplary embodiment of the present disclosure.

### DETAILED DESCRIPTION OF EXEMPLARY EMBODIMENTS

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the scope of the present disclosure.

Prior to describing the exemplary embodiments of the present disclosure in detail, first, the terminology used herein will be described in detail, as follows.

First, the term “read sequence” (or abbreviated as “read”) refers to genome sequence data having a short length, which is output from a genome sequencer. Reads generally vary in length ranging from approximately 35 to 500 by (base pairs) according to the kind of a genome sequencer. In general, DNA bases are represented by four characters: A, C, G, and T.

The term “target genome sequence” refers to a genome sequence (a reference sequence) used for reference to produce a full-length genome sequence from the reads. In analysis of the genome sequence, a large amount of reads output from a genome sequencer are mapped with reference to a target genome sequence to complete the full-length genome sequence. According to the present disclosure, the target genome sequence may be a sequence (for example, a full-length human genome sequence, etc.) set in advance upon analysis of a genome sequence, or a genome sequence synthesized in a genome sequencer may also be used as the target genome sequence.

The term “base” refers to a basic unit constituting a target genome sequence and a read. As described above, the DNA bases may include four letters: A, C, G, and T, each of which is referred to as a base. That is, the DNA bases are represented by four bases. Also, this is applicable to the reads in like manner.

The term “fragment sequence” (or abbreviated as “fragment”) refers to a sequence which is a basic unit used when a read is compared with a target genome sequence so as to map the read. In theory, mapping positions of reads should be calculated while sequentially comparing the entire read with the target genome sequence beginning from the 1st base of the target genome sequence so as to map the read to the target genome sequence. However, such a method has a problem in that large amounts of time and computing power are required to map one read. Therefore, a fragment that is a piece that is actually composed of a portion of the read is first mapped to the target genome sequence to search for a mapping candidate position of the entire read and map the entire read at a corresponding candidate position (global alignment).

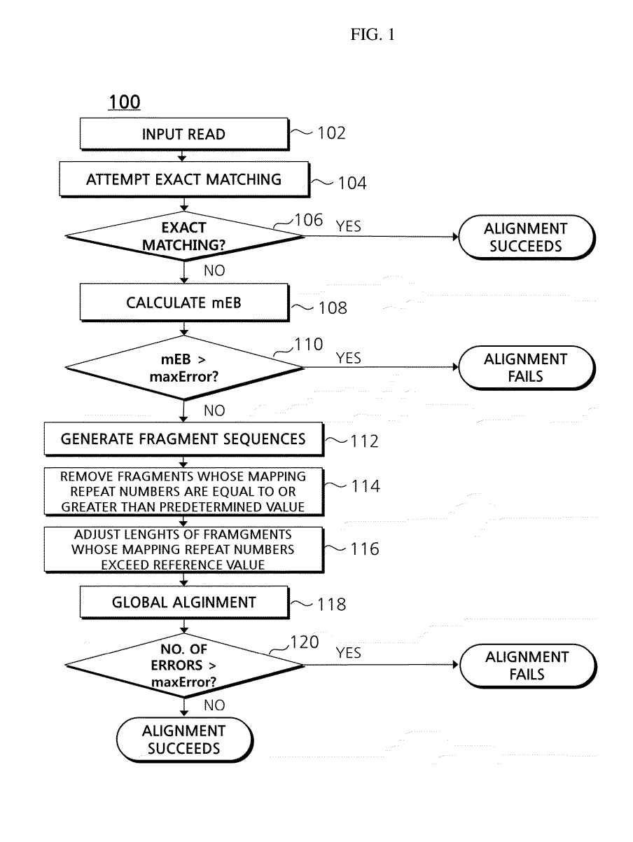

FIG. 1 is a diagram explaining a method 100 of aligning a genome sequence according to one exemplary embodiment of the present disclosure. According to one exemplary embodiment of the present disclosure, the method 100 of aligning a genome sequence refers to a series of processes including comparing reads output from a genome sequencer with a target genome sequence and determining a mapping (or aligning) position of the read on the target sequence so as to construct the entire sequence.

First, when reads are outputted from a genome sequencer (Operation 102), exact matching of the entire read with the target genome sequence is attempted (Operation 104). From the results of this attempt, when the exact matching of the entire read succeeds, the alignment is considered to be succeeded without performing an alignment operation (Operation 106). From the results of experiments on human genome sequences, when 1,000,000 reads output from a genome sequencer are exactly matched with the human genome sequences, 231,564 cycles of the exact matching appear to take place in a total of 2,000,000 alignments (1,000,000 alignments for a forward sequence, and 1,000,000 alignments for a reverse complementary sequence). Therefore, the results obtained in Operation 104 show that a work load required for the alignments may be reduced by approximately 11.6%.

On the other hand, when the corresponding read is judged not to be exactly matched in Operation 106, an error margin e, which may occur when the corresponding read is aligned on the target sequence, is calculated (Operation 108).

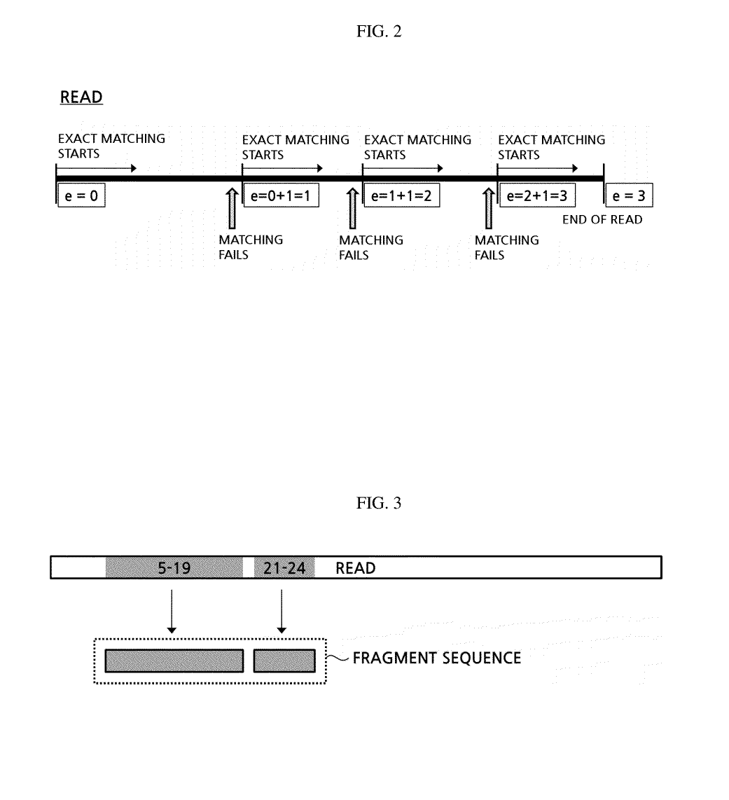

FIG. 2 is a diagram exemplifying a process of calculating an error margin e in Operation 108. As shown in FIG. 2, an initial error margin is first set to 0 (e=0), and exact matching is attempted while migrating from a 1st base of a read one by one in a right direction. In this case, if it is assumed that further exact matching from a certain base (a base indicated by a 1st arrow from the left in the drawing) of the read is impossible to perform, this means that an error takes place somewhere in a section spanning from a matching start position to a current position of the read. Therefore, the error margin is increased by one accordingly (e=1), and new exact matching starts at the next position. Next, when the exact matching is judged to be impossible to perform again, another error takes place somewhere in another section spanning from a position at which the exact matching re-starts to a current position. As a result, the error margin is increased again by one (e=2), and new exact matching starts at the next position. The error margin (e=3 in the drawing) when the end of the read is reached through such a process becomes the number of errors that may occur in the corresponding read. In this case, the value e is an error margin because the number of all the errors that may occur in the read is not investigated, but is inspected only at one position of a target sequence using a method of performing new exact matching from a point of time at which an error occurs at a certain site in the read. That is, the value e may be a minimum value of errors that may occur in the corresponding read, and more errors may occur in other sites of the target sequence.

When the error margin of the read is calculated through such a process, it is judged whether the calculated error margin exceeds a predetermined error allowable value (maxError) (Operation 110). When the calculated error margin exceeds the error allowable value, alignment of the corresponding read is judged to have failed, and the alignment is then terminated. In the above-described experiments on the human genome sequences, when the error margins of the other reads are calculated on the assumption that the maximum error allowable value (maxError) is set to 3, it is shown that the error margins of the reads corresponding to a total of 844,891 cycles exceed the maximum error allowable value. That is, the results obtained in Operation 108 show that a work load required for the alignments may be reduced by approximately 42.2%.

On the other hand, when the results of the judgment in Operation 110 show that the calculated error margin is equal to or less than the maximum error allowable value, alignment on the corresponding read is performed as follows.

First, a plurality of fragment sequences are produced from the read (Operation 112), and a filtering process of discarding the fragment sequences whose mapping repeat numbers in the target sequence exceed a predetermined upper limit from the plurality of produced fragment sequences is performed (Operation 114). Next, the fragment sequences whose mapping repeat numbers in the target sequence exceed the predetermined reference value are selected from the produced fragment sequences, and lengths of the selected fragment sequences are adjusted until the mapping repeat numbers of the selected fragment sequences reach a value equal to or less than the reference value (Operation 116). In this case, Operations 114 and 116 may be performed together, or only one of Operations 114 and 116 may be performed.

Subsequently, global alignment on the read is performed using the fragment sequence (Operation 118). In this case, it is noted that the fragment sequences for which the global alignment is performed in Operation 118 include all the fragment sequences whose lengths are adjusted in Operation 116, and also the fragment sequences whose lengths are not adjusted in Operation 116, that is, fragment sequences whose lengths need not be adjusted since the mapping repeat numbers are equal to or less than the reference value. From the results of the global alignment, when the number of errors in the read exceeds a predetermined error allowable value (maxError), the alignment is judged to have failed, and alignment is judged to have succeeded when the number of errors in the read does not exceed the predetermined error allowable value (Operation 120).

Hereinafter, specific processes including Operations 112 to 116 will be described in detail.

Producing a Plurality of Fragment Sequences from Read (Operation 112)

This operation is to produce fragment sequences which are a plurality of small pieces from a read so as to perform alignment of the read. In this operation, a plurality of fragment sequences are produced in consideration of some or all of the read. For example, the fragment sequences may be produced by dividing all of the read or a certain section of the read or combining the divided pieces. In this case, the produced fragment sequences may be sequentially ligated to each other, but the present disclosure is not limited thereto. For example, it is possible to constitute the fragment sequences as a combination of pieces spaced apart from each other in the read. Also, the produced fragment sequences do not necessarily have the same length, and thus it is possible to produce fragment sequences having various lengths in one read. In the present disclosure, for example, a method of producing fragment sequences from a read is not particularly limited. For example, various algorithms of extracting fragment sequences from some or all of the read may be used without limitation.

Filtering Produced Fragment Sequences (Operation 114)

When the fragment sequences are produced through such a process, mapping repeat numbers in the target sequence are calculated for the produced fragment sequences, and a filtering process of discarding the fragment sequence whose calculated mapping repeat numbers exceed a predetermined upper limit is performed. In this case, the mapping repeat number means the frequency at which exact matching occurs upon mapping of the fragment sequences with the target sequence.

In general, the target genome sequence (for example, a human genome) includes a large number of repeat sequences. Such repeat sequences are distributed at various positions of the target sequence, and repeatedly include the same genome sequence. As a result, when some fragment sequences are mapped to the target sequence, the exact matching occurs at a plurality of positions. In this case, the exact mapping positions are determined by performing the global alignment at positions at which the exact matching takes place. However, when an excessive amount of such mapping repeat numbers is present in the target sequence, unnecessary cycles of the global alignment may be performed. In this case, since the unnecessary cycles of the global alignment have an adverse effect on complexity and accuracy of an algorithm for aligning a full-length sequence, when the mapping repeat number exceeds a predetermined upper limit, the corresponding fragment sequences are discarded so as to prevent an excessive increase in operating rate and complexity of the algorithm for aligning a full-length sequence.

In this case, the upper limit may be determined in consideration of the kind of a target genome sequence and a length of a fragment sequence. From the experimental results, the upper limit is set to 10,000 when the fragment sequence has a length of 15 bp. This is because it is desirable to improve accuracy and an operating rate of genome sequence recombination.

Adjusting Lengths of Fragment Sequences (Operation 116)

Meanwhile, in addition to the fragment sequences whose mapping repeat numbers are excessively large, that is, exceed the upper limit as described above, some of the fragment sequences having a relatively high mapping repeat number with respect to the target sequence still have an adverse effect on complexity and accuracy of the algorithm for aligning a full-length sequence. Therefore, it is necessary to reduce the mapping repeat number of the fragment sequences using a suitable method.

For this purpose, in this operation, the fragment sequences in which the number of mapping positions in the target sequence exceeds a predetermined reference value are selected from the candidate fragment sequences, and a size of the corresponding fragment sequence is adjusted (expanded) until the number of mapping positions for the selected fragment sequences reaches a value equal to or less than the predetermined reference value.

More particularly, the number of mapping positions in the target sequence is calculated for each of the candidate fragment sequences, the fragment sequences in which the number of calculated mapping positions exceeds the predetermined reference value are selected, and the sizes of the selected fragment sequences are expanded until the number of mapping positions in the target sequence reaches a value equal to or less than the predetermined reference value.

In this case, the size expansion of the selected fragment sequences may be realized by adding or appending one or more bases, which constitute a portion of the read, to the selected fragment sequences. In this case, the expanding bases are not necessarily adjacent to the fragment sequence. For example, it is also possible to add a piece extracted at 21^{st} to 24^{th} positions of a read so as to expand a fragment sequence extracted at 5^{th} to 19^{th} positions of the read, as shown in FIG. 3.

Also, the size expansion of the selected fragment sequences may be realized by adding bases in the read corresponding to the corresponding positions to the beginnings or ends of the selected fragment sequences. The size expansion will be described as one example as follows. For example, assume that a fragment sequence is produced from a read as follows.

Read: A T T G C C T C A G T

Fragment sequence: T T G C (the underlined sequence in the read)

When the mapping result for the fragment sequence shows that the number of mapping positions in a target sequence is 65, and a predetermined reference value is 50, a length of the fragment sequence is expanded by one base pair until the number of mapping positions reaches a value equal to or less than the reference value, as follows.

T T G C (65 mapping positions)

T T G C C (54 mapping positions)

T T G C C T (27 mapping positions)

In this example, when two bases inside a read are added to the fragment, the number of mapping positions decreases to a value equal to or less than the reference value. As a result, the final fragment sequence becomes a sequence of T T G C C T, whose length is 2 base pairs longer than the initial length of the fragment. Meanwhile, like another example described above, the reference value may be properly determined according the characteristics of the target sequence, the read and the fragment sequence. Therefore, it should be noted that the certain set values are not intended to limit the scope of the present disclosure.

Meanwhile, when the expanding fragment sequence is not mapped to the target sequence during a process of expanding a length of the fragment sequence as described above, that is, when the number of mapping positions in the expanding fragment sequence is null (0), the corresponding fragment sequence is discarded. For example, it is assumed that a length of the fragment sequence is expanded as follows.

A C G G (270 mapping positions)

A C G G T (55 mapping positions)

A C G G T A (0 mapping positions)

In the case of the fragment sequence, the number of mapping positions in the target sequence exceeding the reference value is 55 for a fragment sequence whose length is expanded by one base from the original fragment sequence (A C G G), and a fragment sequence whose length is expanded by two bases is not mapped to the target sequence at all. That is, since the number of mapping positions is too high when the length of the fragment sequence is expanded by one base and the fragment sequence is not mapped to the target sequence when the length of the fragment sequence is expanded by two bases, the corresponding fragment sequence is discarded without use in the subsequent global alignment process.

In the experiments on the human genome sequences, when fragment sequences having a length of 15 bp are produced at a shift distance of 4 by from 1,000,000 reads and the produced fragment sequences are matched with a target sequence, it was revealed that approximately 77% of a total of 15,547,856 fragment sequences have 50 or fewer mapping positions on the assumption that a reference value is set to 50. That is, the experimental results show that 77% of the fragment sequences may be used without base addition, and the remaining 23% of the fragment sequences have to be subjected to fragment sequence expansion using the above-described method when the reference value is set to 50.

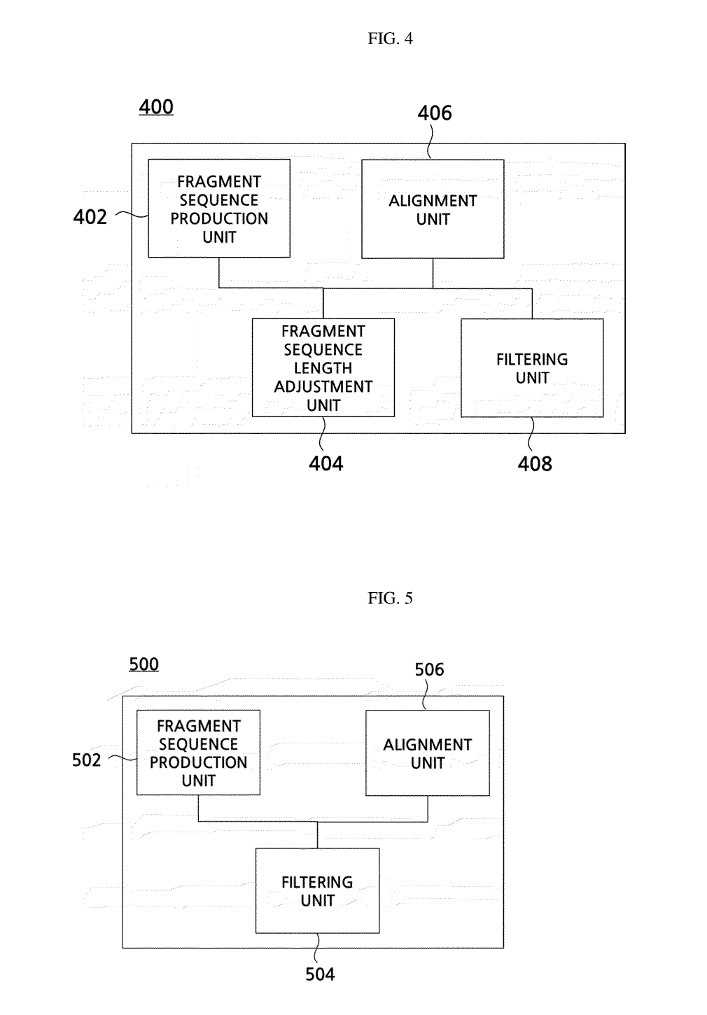

FIG. 4 is a block diagram showing a system 400 for aligning a genome sequence according to one exemplary embodiment of the present disclosure. The system 400 for aligning a genome sequence according to one exemplary embodiment of the present disclosure is a device for performing the above-described method of aligning a genome sequence, and includes a fragment sequence production unit 402, a fragment sequence length adjustment unit 404 and an alignment unit 406. As necessary, the system 400 for aligning a genome sequence may further include a filtering unit 408.

The fragment sequence production unit 402 produces a plurality of fragment sequences from a read obtained in a genome sequencer.

The fragment sequence length adjustment unit 404 selects the fragment sequences whose mapping repeat numbers in a target sequence exceed a predetermined reference value from the plurality of produced fragment sequences, and adjusts lengths of the selected fragment sequences until the mapping repeat numbers of the selected fragment sequences reach a value equal to or less than the reference value. In this case, the fragment sequence length adjustment unit 404 may adjust the lengths of the selected fragment sequences by adding one or more bases constituting a portion of the read to the selected fragment sequences. In this case, the fragment sequence length adjustment unit 404 may also adjust the lengths of the selected fragment sequences by adding bases in the read corresponding to the corresponding positions to the beginnings or ends of the selected fragment sequences.

The alignment unit 406 performs global alignment on the target sequence of the read using the fragment sequences. In this case, it is noted that the fragment sequences in which the global alignment is performed at the alignment unit 406 include all the fragment sequences whose lengths are adjusted at the fragment sequence length adjustment unit 404, and also the fragment sequences whose lengths are not adjusted at the fragment sequence length adjustment unit 404, that is, fragment sequences whose lengths do not need to be adjusted since the mapping repeat numbers are equal to or less than the reference value.

The filtering unit 408 discards the fragment sequences whose mapping repeat numbers in the target sequence exceed the predetermined upper limit when there are such fragment sequences among the plurality of fragment sequences produced at the fragment sequence production unit 402. In this case, the upper limit may be 10,000, as described above.

FIG. 5 is a block diagram showing a system 500 for aligning a genome sequence according to another exemplary embodiment of the present disclosure. As shown in FIG. 5, the system 500 for aligning a genome sequence according to this exemplary embodiment includes a fragment sequence production unit 502, a filtering unit 504 and an alignment unit 506.

The fragment sequence production unit 502 produces a plurality of fragment sequences from the read obtained in a genome sequencer.

The filtering unit 504 discards the fragment sequences whose mapping repeat numbers in the target sequence exceed the predetermined upper limit when there are such fragment sequences among the plurality of fragment sequences produced at the fragment sequence production unit 502. In this case, the upper limit may be 10,000, as described above.

The alignment unit 506 performs global alignment on the target sequence of the read using the fragment sequences filtered through the filtering unit 504.

Meanwhile, the exemplary embodiments of the present disclosure may include a computer-readable recording medium equipped with programs for executing the methods described herein on a computer. The computer-readable recording medium may include program commands, local data files, local data structures, etc., which may be used alone or in combination. The computer-readable recording medium may be particularly designed or constructed for the purpose of the present disclosure, or may also be known and used by persons of ordinary skill in computer software-related art. Examples of the computer-readable recording medium may include magnetic media such as hard disks, floppy disks and magnetic tapes, optical recording media such as CD-ROMs and DVDs, magneto-optical media such as floppy disks, and hardware devices, such as ROMs, RAMs and flash memories, which are particularly constructed to store and execute the program commands. Examples of the program commands may include high-level language codes capable of being executed by a computer using an interpreter, as well as machine codes such as those constructed by compilers.

According to the exemplary embodiments of the present disclosure, the mapping accuracy may be improved and the mapping rate may be enhanced by properly expanding lengths of the fragment sequences produced in the read according to the mapping repeat numbers of the fragment sequences in the target genome sequence or discarding the fragment sequences in which the number of mapping positions in the target genome sequence is too high without fixing the lengths of the fragment sequences.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. A system, intended for use in aligning a genome sequence, the system comprising a computer executing program commands and thereby implementing:
a fragment sequence production unit configured to produce a plurality of fragment sequences from a read;
a fragment sequence length adjustment unit configured to:
obtain, for each fragment sequence of the plurality of fragment sequences, a corresponding mapping repeat number with respect to a target sequence;
select ones of the plurality of fragment sequences having corresponding mapping repeat numbers exceeding a predetermined reference value; and
adjust respective lengths of the selected ones of the plurality of fragment sequences until the corresponding mapping repeat numbers do not exceed the predetermined reference value; and
an alignment unit configured to perform a global alignment operation using the plurality of fragment sequences.

2. The system of claim 1, wherein the fragment sequence length adjustment unit is further configured to adjust the respective lengths of the selected ones of the plurality of fragment sequences by adding one or more bases to the selected ones of the plurality of fragment sequences.

3. The system of claim 2, wherein the fragment sequence length adjustment unit is further configured to add the one or more bases by:
extracting the one or more bases from corresponding positions of the read; and
appending the extracted one or more bases to the beginnings or ends of the selected ones of the plurality of fragment sequences.

4. The system of claim 1, wherein:
the ones of the plurality of fragment sequences having adjusted lengths constitute adjusted fragment sequences;
the fragment sequence length adjustment unit is further configured to make a determination as to whether a given one of the adjusted fragment sequences maps to the target sequence; and
the fragment sequence length adjustment unit is further configured to respond to a determination, that the given one of the adjusted fragment sequences does not map to the target sequence, by discarding the given one of the adjusted fragment sequences.

5. The system of claim 1, further comprising a filtering unit configured to discard any of the selected ones of the fragment sequences having corresponding mapping repeat numbers, in the target sequence, exceeding a predetermined upper limit.

6. The system of claim 5, wherein the predetermined upper limit is 10,000.

7. A system, intended for use in aligning a genome sequence, the system comprising a computer executing program commands and thereby implementing:
a fragment sequence production unit configured to produce a plurality of fragment sequences from a read;
a filtering unit configured to:
receive, for each of the plurality of fragment sequences, a corresponding mapping repeat number with respect to a target sequence; and
discard any of the plurality of fragment sequences having corresponding mapping repeat numbers, in the target sequence, exceeding a predetermined upper limit; and
an alignment unit configured to perform a global alignment operation using a remainder of the plurality of fragment sequences.

8. The system of claim 7, wherein the predetermined upper limit is 10,000.

9. A method, intended for use in aligning a genome sequence, the method comprising:
producing, with a fragment sequence production unit, a plurality of fragment sequences from a read;
using a fragment sequence length adjustment to:
obtain, for each fragment sequence of the plurality of fragment sequences, a corresponding mapping repeat number with respect to a target sequence;
select ones of the plurality of fragment sequences having corresponding mapping repeat numbers exceeding a predetermined reference value; and
adjust respective lengths of the selected ones of the plurality of fragment sequences until the corresponding mapping repeat numbers do not exceed the predetermined reference value; and
performing, with an alignment unit, a global alignment operation using the plurality of fragment sequences.

10. The method of claim 9, wherein the adjusting of the lengths of the selected ones of the plurality of fragment sequences comprises adding one or more bases to the selected ones of the plurality of fragment sequences.

11. The method of claim 10, wherein the adding of the one or more bases comprises:
extracting the one or more bases from corresponding positions of the read; and
appending the extracted one or more bases to the beginnings or ends of the selected ones of the plurality of fragment sequences.

12. The method of claim 9, wherein:
the ones of the plurality of fragment sequences having adjusted lengths constitute adjusted fragment sequences; and
the adjusting of the lengths of the selected fragment sequences further comprises:
making a determination as to whether a given one of the adjusted fragment sequences maps to the target sequence; and
responding to a determination, that the given one of the adjusted fragment sequences does not map to the target sequence, by discarding the given one of the adjusted fragment sequences.

13. The method of claim 9, further comprising discarding any of the selected ones of the fragment sequences having corresponding mapping repeat numbers, in the target sequence, exceeding a predetermined upper limit.

14. The method of claim 13, wherein the predetermined upper limit is 10,000.

15. A method, intended for use in aligning a genome sequence, the method comprising:
producing, with a fragment sequence production unit, a plurality of fragment sequences from a read;
using a filtering unit to:
receive, for each of the plurality of fragment sequences, a corresponding mapping repeat number with respect to a target sequence; and
discard any of the plurality of fragment sequences having corresponding mapping repeat numbers, in the target sequence, exceeding a predetermined upper limit; and
performing a global alignment operation using a remainder of the plurality of fragment sequences.

16. The method of claim 15, wherein the predetermined upper limit is 10,000.
